(19) United States
(12) Patent Application Publication
(10) Pub. No.: US 2020/0195042 A1
(43) Pub. Date: Jun. 18, 2020

(54) HANDHELD ELECTRONIC DEVICE CHARGING GLOVES

(71) Applicant: Elizabeth S. Topolosky, Los Angeles, CA (US)

(72) Inventor: Elizabeth S. Topolosky, Los Angeles, CA (US)

(21) Appl. No.: 16/708,305

(22) Filed: Dec. 9, 2019

Related U.S. Application Data
(60) Provisional application No. 62/780,464, filed on Dec. 17, 2018.

(51) Int. Cl. H02J 50/00; H02J 7/00; H02J 50/70; A41D 19/00; A41D 31/10; A41D 31/26

(52) U.S. Cl. CPC H02J 50/005; H02J 7/0044; H02J 50/70; H02J 2207/40; A41D 31/10; A41D 31/26; A41D 19/0024

(57) ABSTRACT

A wearable charging device for the palm of one's hand. It is meant to recharge today's typical cell phone (or other electronic device) while that phone (or device) is being held and in use. A first embodiment incorporates a wireless charging station into the palm region of a wearable glove. An alternative version extends a replaceable, rechargeable power bank front or rear glove face, or into a lower cuff region of the glove.

### CROSS-REFERENCE TO RELATED APPLICATIONS

This application is a perfection of U.S. Provisional Application Ser. No. 62/780,464, filed on Dec. 17, 2018, the disclosure of which is fully incorporated herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### (1) Field of the Invention

The present invention relates to a wearable glove with integral (or built-in) charging/recharging for an electronic device, such as a handheld game unit, Ipad or tablet or cell phone (regardless of brand). Alternately, this invention addresses wearable gloves having means for connecting to one's own power bank/cell unit.

Particularly, this invention addresses a glove that has: (a) internal means and connections for a rechargeable, portable power bank; or (b) a wireless charging pad for the palm area of the glove. The power bank may be a new unit customized for a handheld glove end use. Or the glove can incorporate practical design alterations, e.g., slitting and wiring options, for a wearer to use his/her own, pre-existing power bank units. Sewn in wiring connections would be critical for the latter alternatives. They would allow a charging cord (from a power bank or charging pad) to be fed through a glove (either the left or right hand), and then held in place, close to the body of the electronic device to be charged therewith, yet still out of the way.

This glove may keep its charging means intact, especially when made integral with the glove, to periodically recharge its power unit(s) when not worn for a given period of time. Or, the glove may have its replaceable power storage units removed therefrom for recharging externally, before being replaced in the confines of the glove proper. The use of this invention will advantageously extend the useable life of electronic devices, tablets, game playing units and/or cell phones through the business day or into early evening hours by enabling recharging while the device is still being used for business, personal and/or recreational purposes.

In ever increasing numbers, people are carrying/using their electronic devices, particularly their smart and other cell phones for hours . . . every day. They walk and talk with them, drive with them (though they shouldn't drive AND use the device concurrently) and conduct non-stop business transactions with/on them. Despite growing battery power improvements with such phones, there are days when the device “dies” or needs to be put on forced downtime for recharging. Continuous use for 4+ hours, with many apps open, quickly drains a cell phone's power units down to unusable levels.

What is needed is means for NOT draining the power from a continuously held-continuously used device such as a cell phone but rather one that can actually restore power to the unit while the phone is being held—and in use! This invention meets that need with several alternative variations.

### (2) Description of Related Art Including Information Disclosed Under 37 CFR 1.97 and 1.98

It is known to keep power banks of various shapes and sizes handy when needed for adding external “juice” to an electronic device (game unit, cell phone, Ipad, laptop or the like). Such units are externally charged and then carried about in one's purse, briefcase, etc. until needed in a pinch. Then, at least one cable is run from the bank to the phone proper for interconnectivity charging. It is NOT easy to continue using a phone joined by an elongated power cord to any such phone bank mechanism.

Wireless phone charging is growing in popularity. With such permanently plugged in devices, one can merely place his/her phone on such charging pads (located on a work desk, on the entry table to the home, kitchen or office) and recharge the phone for the next day's use. What if re-chargeability was made more portable, more convenient, less tedious? Enter the PowerGlove™, where the power is in your hands.

There are several concepts that the present invention clearly distinguishes over. Particularly, there is a wristband phone charger/jewelry device like those shown in Published U.S. Patent Application No. 20150115870 and Published U.S. Patent Application No. 20160056650. Yet another disclosure teaches wearing a portable charger about one's neck as in Published U.S. Patent Application No. 20160087470.

There are also several known gloves that are used to hold (but never charge) a cellular phone. See, e.g., Published U.S. Patent Application No. 20070101479 and Published U.S. Patent Application No. 20170179995. In the same vein, there is a Bluetooth-compatible glove made by Ideas in Life and sold on Amazon.com.

### BRIEF SUMMARY OF THE INVENTION

The present invention relates to a wearable charging device for the palm of one's hand. It is meant to recharge today's typical cell phone (or other electronic hand-held device) WHILE that phone (or other device) is being held and in use. In a first embodiment, it incorporates a wireless charging station into the palm of a wearable glove. An alternative version extends a replaceable, rechargeable power bank directly into a wearable glove with the powering line from that power bank extending upwardly for use as needed.

Options for the glove itself include a fingerless variation, a glove with touchpad fingertips, charging ports for either or both gloves (left-handed OR right-handed) and power cord variations (i.e., a permanently wired glove, or an ability to insert one's own existing cord through pre-made channels in the glove body. Ideally, there would be a more heavy duty glove version, for use by construction workers or the like.

### BRIEF DESCRIPTION OF THE SEVERAL VIEWS OF THE DRAWING(S)

Further features, advantages and objectives of this invention will be made clearer with the following detailed description made with reference to the accompanying drawings in which:

FIG. 1A is a front plan view of a right-handed glove with a square-shaped phone charging pad incorporated into the palm area of said glove;

FIG. 1B is a front plan view of a first alternative round charging pad for use with the present invention;

FIG. 1C is a front plan view of the bottom to a second alternative, trapezoid-shaped charging pad for use with the present invention;

FIG. 2 is a side perspective view of a right-handed glove with a flat charging unit built into its palm, said glove further including touchpad fingertips;

FIG. 3 is a close up, sectional view of a right glove showing both an internal insulation layer alternative and an external outer layer cover option;

FIG. 4A is a close up front view of a lower glove according to another alternative of this invention, said glove including a cord-connecting, feed through slit near the base of the glove palm;

FIG. 4B is a front plan view of an alternative to FIG. 4A in which a connecting power cord has been permanently sewn (or stitched) into the base of the glove palm area;

FIG. 5 is a front plan view of another alternative of this invention showing an added glove cuff holster for a removable, rechargeable power bank;

FIG. 6A is a close up, front plan view of a cuff holster with a top opening pocket;

FIG. 6B is a close up, front view of an alternative, zip holster cuff pocket for another glove variation of the present invention;

FIG. 6C is a close up, front view of another holster cuff alternative made using a plurality of overlapping Velcro® straps;

FIG. 7A is a close up, front view showing one variation of USB port wiring through a glove cuff to a holster held power bank charger;

FIG. 7B is a side, sectional view of the holster wiring from FIG. 7A;

FIG. 7C is a side, sectional view of an alternative holster wiring arrangement to that shown in FIGS. 7A and B, said alternative including a glove cuff slit through which a cord may be passed for connecting to a palm power pad according to this invention;

FIG. 8 is a front plan view to a zippered cuff pocket, slit-wire front wrist variation of glove charger;

FIG. 9 is a close up, front view of the circled region IX from FIG. 8;

FIG. 10 is a side sectional view of a lower region of cuff charger with a more permanent, cord storage sewing into the holster interior adjacent a zippered bank holster;

FIG. 11 is a front plan view of the front (palm side) to a fingerless glove variation according to this invention;

FIG. 12 is a back plan view of the glove from FIG. 11 with its power bank held in place on a rear side of the glove, opposite the palm side;

FIG. 13 is a close up, side view of the power bank sewn into the back of the glove from FIG. 12;

FIG. 14 is a close up, side sectional view of the pocket, power bank and cuff cord from FIGS. 12 and 13;

FIG. 15 is a top plan view showing an alternative power bank mounting system (using a plurality of Velcro® straps) on a rear (opposite the palm) side of a first fingerless glove alternative according to this invention;

FIG. 16 is a close up view of the USB cord connection hidden into the glove pocket from FIG. 15;

FIG. 17 is a front plan view showing a left-handed glove variation of this invention with variable lengths of power charging cords passing therethrough;

FIG. 18A is a close up, side plan view of a lightning charger cord sewn into the palm of a glove according to this invention;

FIG. 18B is a close up, top plan view showing a power bank cuff holster, and multi-slit charge cord sewn into a pocketed region in the glove hand;

FIG. 18 C is a top plan view of the variation shown at FIG. 18B with charge cord removed for illustration purposes;

FIG. 18D is a side sectional view of the charge cord from FIG. 18B with an optional inner lining layer added thereto;

FIG. 18E is a close up top view showing a glove base alternative with multiple slits through the lower palm and cuff regions through which a power cord may be threaded according to still another alternative embodiment of this invention;

FIG. 19A is a front plan view of another alternative showing a thumb-wrapping charging pad holder;

FIG. 19B is a variation of the alternative at FIG. 19A to which at least one finger wrap around has been added; and

FIG. 19C is a variation of FIG. 19B for wrapping about the wearer's thumb and two fingers.

### DETAILED DESCRIPTION OF THE INVENTION

The present handheld electronic drive charger glove embodiments will be described with reference to the accompanying drawings. It should be noted that while often referring to cell phones below as a first preferred end use application for such gloves, they should be equally useable with still other e-device units, like game players, movie watching units, small I-pads/tablets, etc.

Also, in some of the drawings, alternate variations are depicted, some with optional inclusions. Common elements between versions are commonly numbered, though in the next hundred series.

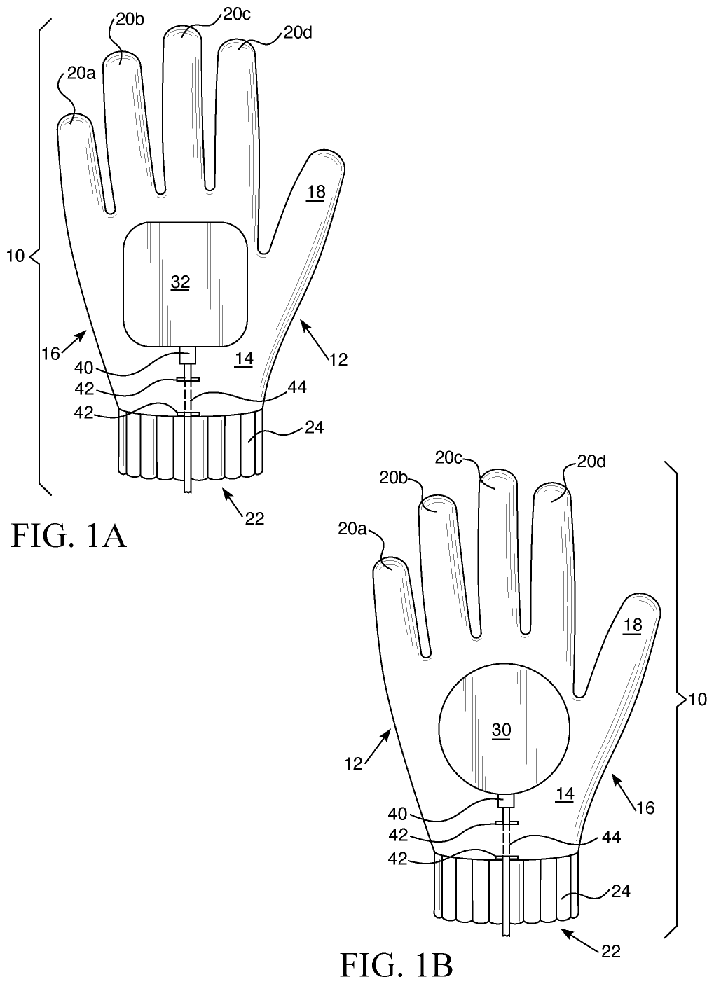

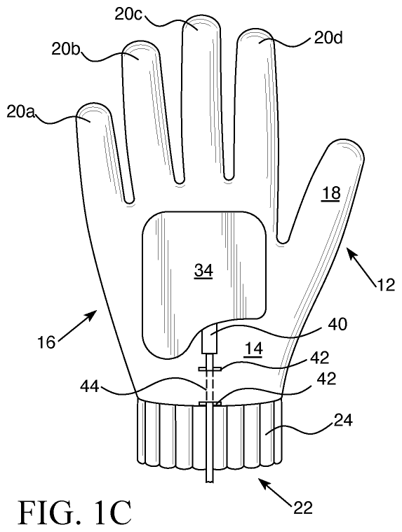

Referring to FIGS. 1A through C, there is shown a first glove palm charger, generally 10, with three different shapes of wireless charge pad. The glove components to this invention consist of a main glove body 12 having a front or palm face 14 and a back hand section 16 with a thumb section 18 and four finger sections 20a-d. Finally, there is at the base of the palm face 14 and back of the hand section 16 an aperture 22 into which the wearer inserts his or her hand. In many instances, especially for cold weather protection, the aperture may be surrounded by cuff region 24. FIGS. 1A through C depict the glove body 12 as worn on the right hand with the palm face 14 in full view. The back-hand section 16 would be on the reverse of this representative right handed glove palm charger 10.

Today's wireless phone pad chargers are generally circular not unlike the circle pad 30 of FIG. 1B. Still others are rectangular, preferably square shaped and sometimes with rounded corners (See, the first alternate pad 32 of FIG. 1A). It is anticipated that with advancing technologies in the wireless charging art, such atypical shapes like the trapezoidal pad configuration 34 at FIG. 1C may be in development and soon in commercial production. Still other known or subsequently developed configurations are also anticipated for incorporation into gloves/hand covers per this invention. Extending downward from each of the foregoing pad configurations is an external charging cord 40. To better secure and protect that cord from unintentional disconnecting and some unnecessary wear-and-tear, it is preferred that cord 40 be passed through one or more glove body slits 42 so as to have some section(s) of cord 40 actually running at least partially inside of main glove body 12 adjacent cuff region 24. The inside component to cord 40 is marked as item 44.

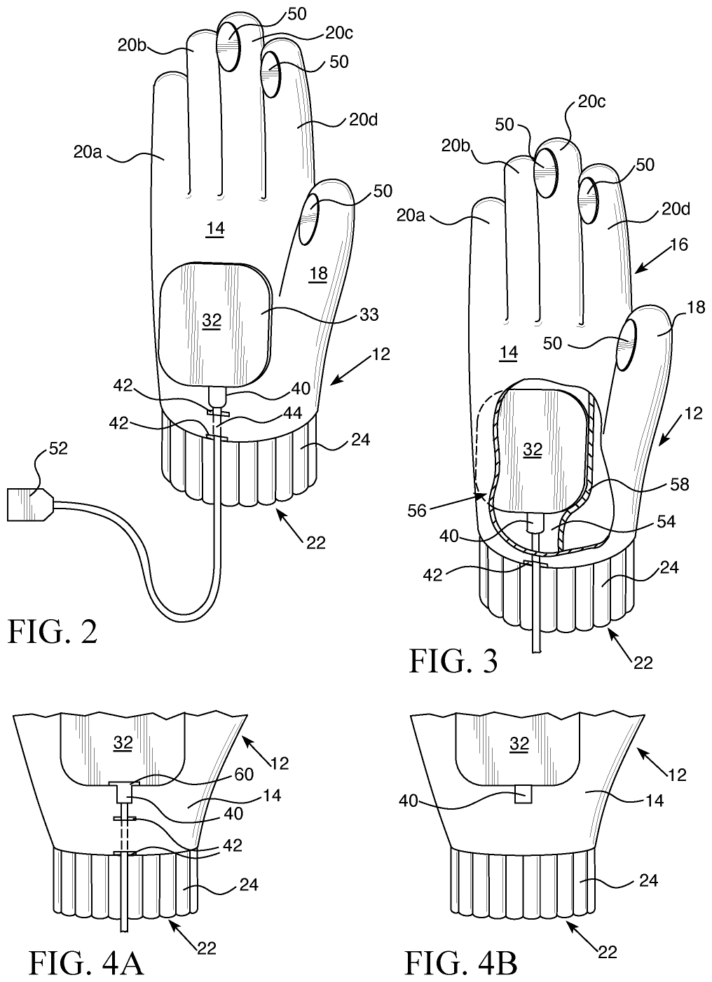

FIG. 2 shows a single layer of glove material for wearing—regardless of outside weather temperatures (warm OR cold) and/or conditions (dry/rainy/snowy). The cell phone charger 32 for that model rests in the glove palm 14 and has an outer surface 33 that may make direct contact the back side of a cell phone (not shown) for charging the latter while that phone is still being held by the glove wearer. FIG. 2 also shows a cord slit for running a charging wire 40 from the main external charger body through a slit in the glove's lowermost palm 14 OR cuff region 24. An adapter end 52 to charging wire 40 may be used for periodically “plugging” one's glove into another supplemental power bank and/or charger (not shown). FIG. 2 also illustrates a plurality of optional fingertip screen surfaces 50 on the glove's thumb 18, pointer 20d and middle 20c fingers.

While FIG. 2 left the exterior to phone charger 32 somewhat exposed to the elements, alternate version FIG. 3 encases such a charger in an interior glove bladder 54 region—with a waterproof outer layer 56 and one or more innermost, insulation layers 58. Such variations may include insulation from: (a) the possibility of heating generated by charging a cell phone in/on one's glove palm; (b) potential radio waves and/or radiation-generation concerns; or (c) both (a) and (b).

FIGS. 4A and B show alternate cord connecting/securing strategies. Cord 40 may be threaded through one or more slits 42 before being just temporarily joined to phone charger 32 at end 60. The zigzagged lines between charger 32 and cord 40 are meant to show that such connections are only temporary. In FIG. 4B, sections of cord 40 may be permanently sewn into place, i.e., beneath a lower most “heel region” of palm 14 and beneath the front face to cuff region 24, as part of a more aesthetic, fashion design statement.

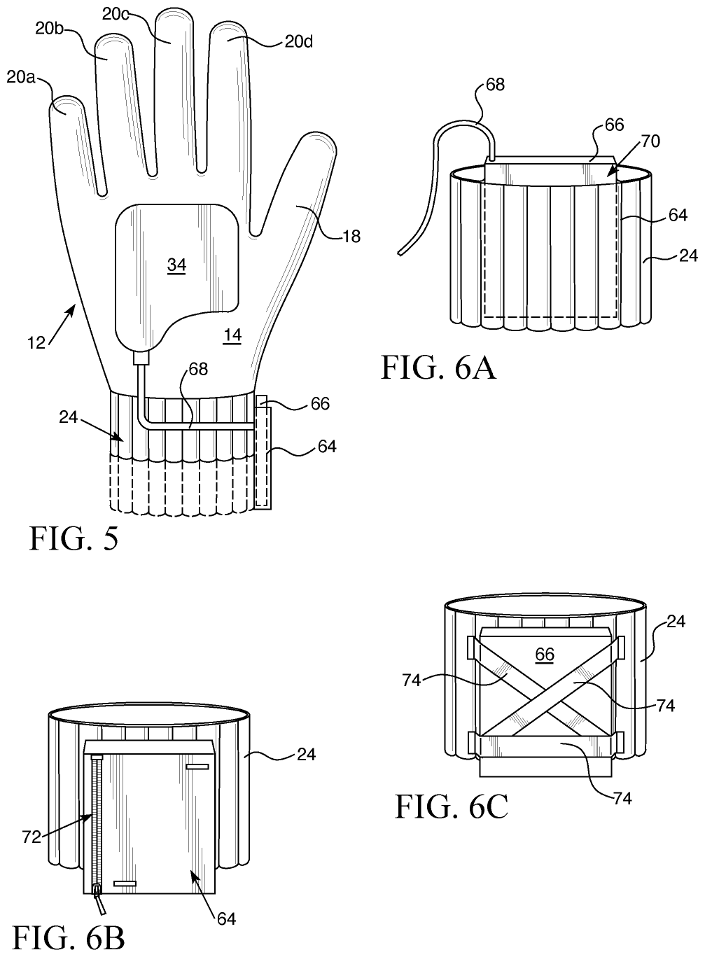

In the cell phone glove charger variation shown at FIG. 5, there is shown a cuff-side holster 64 option for holding exchangeable, interchangeable charging banks 66 that would connect, via wires 68, to palm phone charger 34. As shown, FIG. 5 includes a side cuff holster on the thumb side (18) to this right-handed glove 12. Such holsters can also be supplemented with, or fully replaced by, one or more bank holsters on: (i) the opposite cuff side (i.e. nearest pinky finger 20a) of the same glove, (ii) along the cuff front and/or (iii) rear. The wire connect 68 between phone bank and palm charger may be extended externally (for easier servicing/replacement), integrally added (by threading through one or more lower layers of glove insulation at or near the palm base/upper cuff), or possibly permanently incorporated during the initial manufacture of a new glove set per the present invention.

FIGS. 6A through C depict various configurations of power bank holding cuff holsters 64: FIG. 6A showing one having an open top 70; FIG. 6B having a zippered case 72 variation, especially suitable for short-cuffed glove arrangements in which the charging bank may even exceed overall glove cuff length; and FIG. 6C showing a more simplified covering consisting of two or more Velcro® straps 74 (three straps are shown), said straps forming the very power bank-holding charger pocket at the base of either the left or right handed glove.

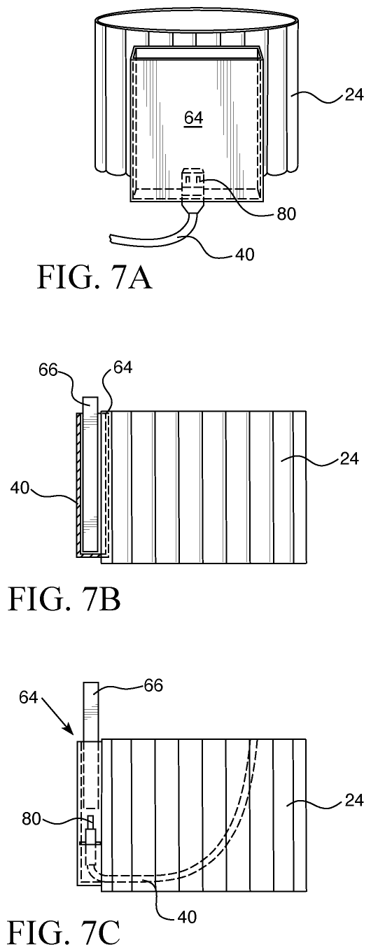

FIGS. 7A through C focus on cord arrangement alternatives for one or more of the aforementioned cuff holster varieties. Particularly, FIG. 7A incorporates a USB connection 80 at the base of its holster 64 for the glove wearer to plug his/her power bank (not shown) into that USB connection. FIG. 7B, by contrast, incorporates a phone charging cord 40 permanently in the outer lining of holster 64 affixed to or incorporated into glove cuff region 24. Such cord wiring may be threaded into and through at least some portion of an existing glove cuff, OR a newly made (knitting/machined, etc.) glove cuff arrangement. Finally, FIG. 7C shows a third variation in which no cord wiring exists outside the holster 64 of cuff region 24. All of the wiring for connecting charge bank 66 via USB port 80 on one end of cord 40 is kept internal to the glove body's cuff region 24. Note, for any of the foregoing, round charging wires or flat ended charging wires may be used. For some applications, the flatter variations may cause less irritation to the glove wearer and be more preferred.

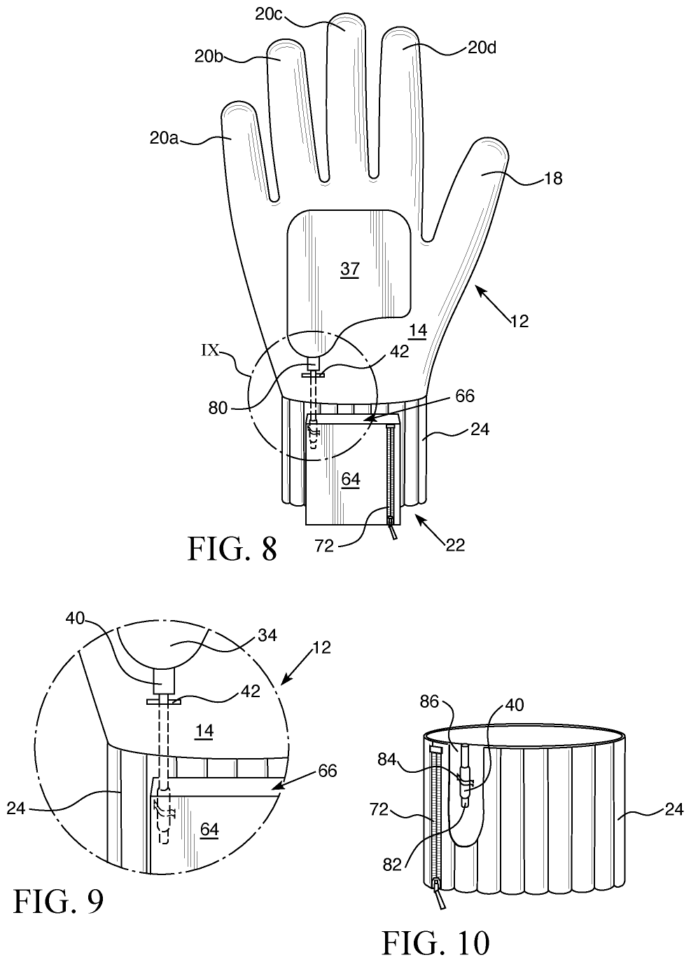

FIGS. 8 and 9 show a front wrist cuff region 24 charger configuration for a representative right-handed glove. That full view variation starts with a trapezoidal palm charger 34 with connection cord 40 extending through a base slit 42 of the palm face 14 to glove 12 for subsequent, periodic connecting to charge bank 66 that can be stored in a zippered 72 front compartment 64.

FIG. 10 shows another alternative in which cuff region 24 of glove charger with the tip 82 to a permanent cord 40 sewn (see item 84) into an interior pocket 86 accessed via cuff zipper 72.

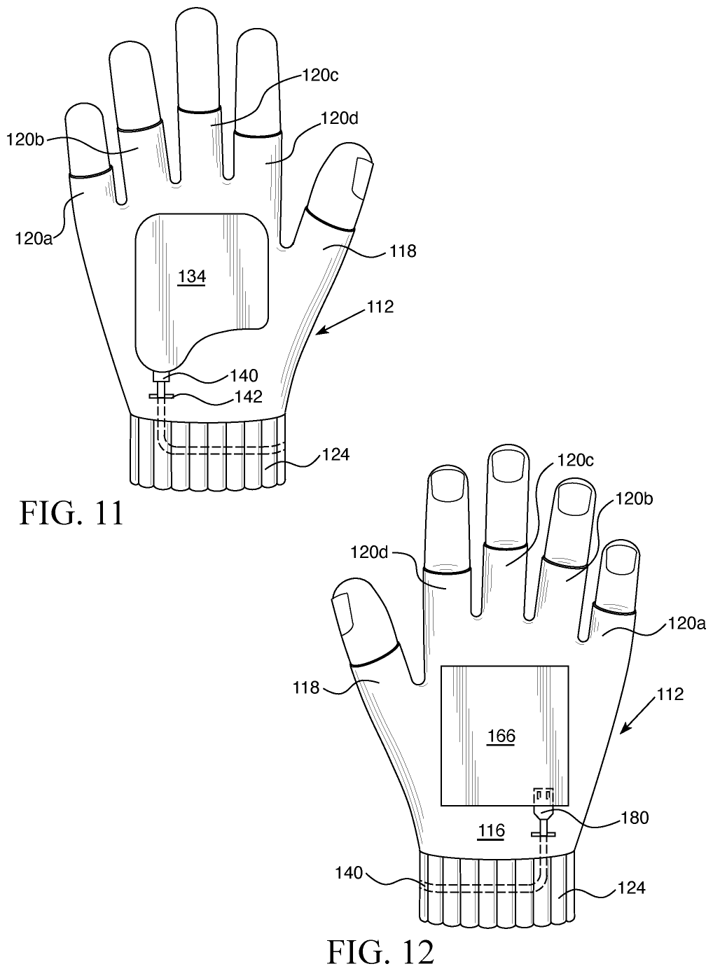

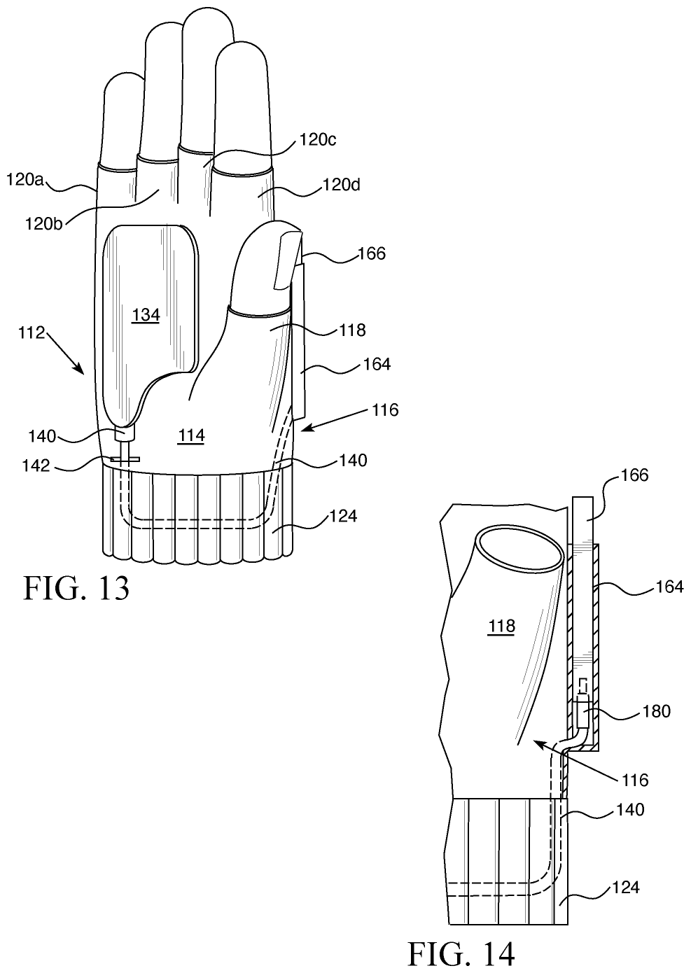

FIGS. 11 through 14 show still other alternative to the cuff system of FIGS. 8 and 9. In a first alternative, glove 112 (with an optional thumbless/fingerless design) has a phone-contacting palm charger 134 connected by a sewn-in cord/wiring element 140 that wraps around the INSIDE of cuff region 124 to the back side 116 of this glove wearer's hand, opposite front palm side 114 where it connects to a replaceable power charge bank 166, stored in holster 164 via USB port 180.

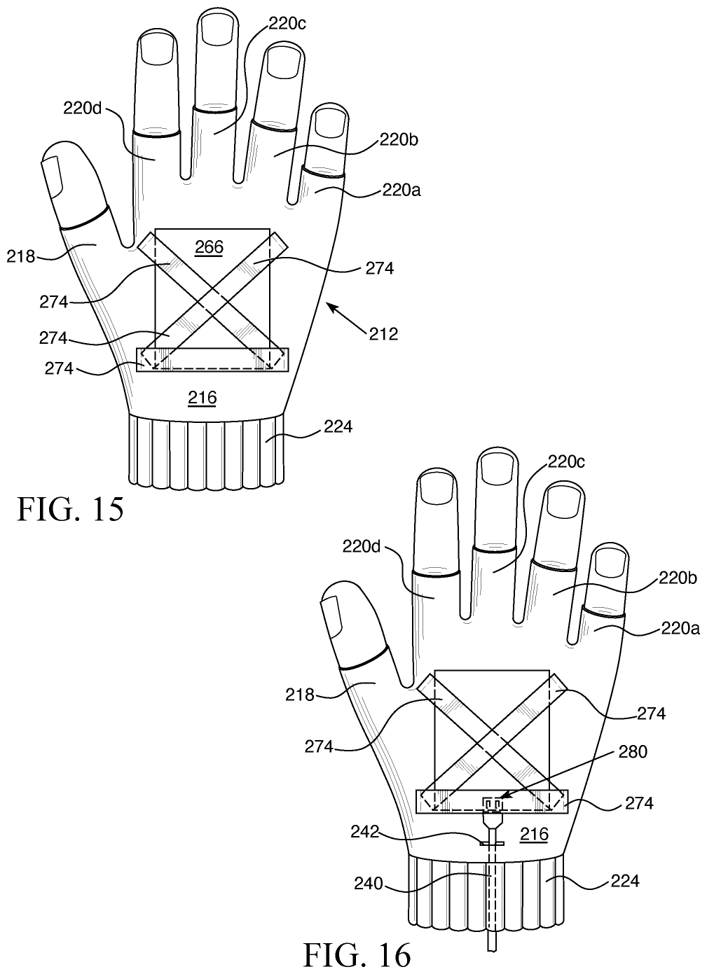

FIG. 15 shows an alternate means for holding a power bank 266 in place to the back side 216 of glove 212. It employs multiple (3 are shown) Velcro® strips 274 for either strapping power bank 266 to the back OR forming a shallow power bank-holding pocket thereon. FIG. 16 shows the USB connection 280 through a lower base slit 242 to the power bank 266 of FIG. 15.

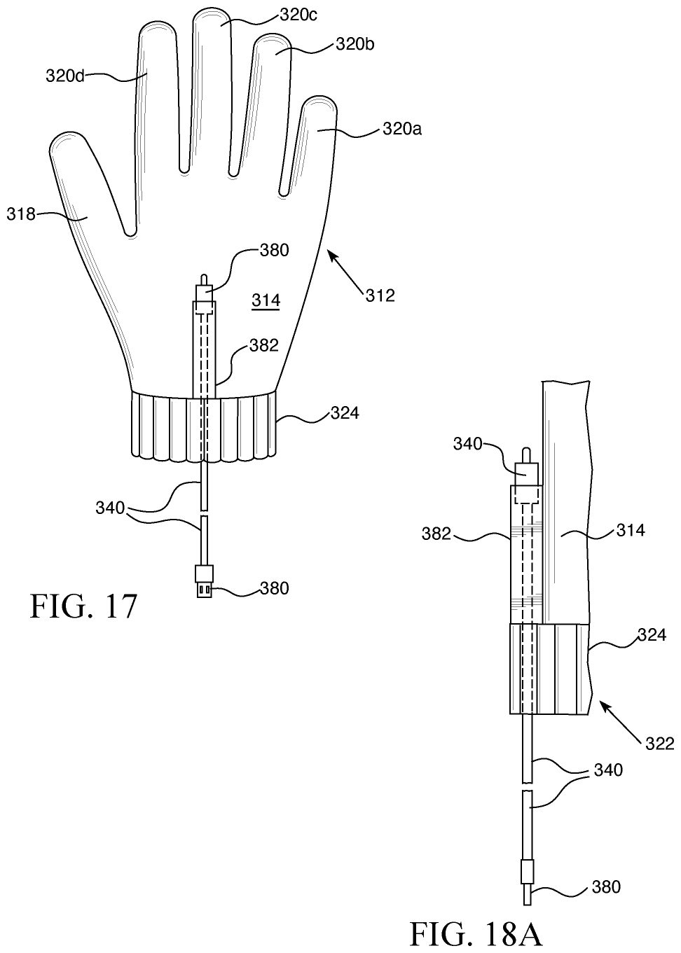

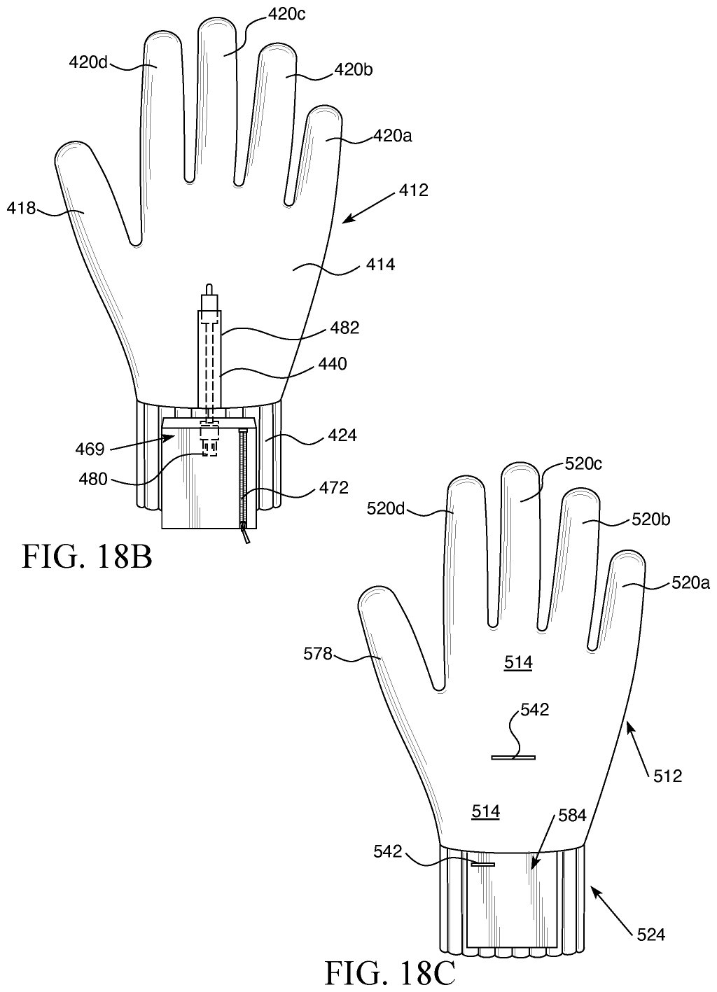

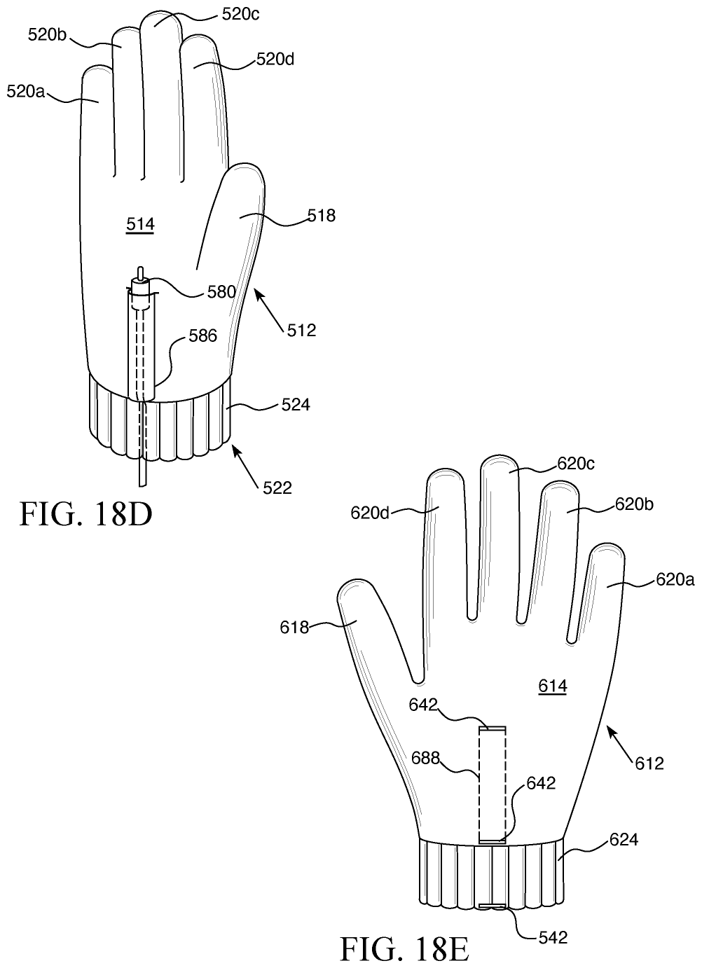

Several variations of port glove alternatives appear in FIGS. 17 and 18A through E. Note the use of a variable length, cord/wire connections 340 (FIG. 17). That variable length of cord/wire can be fixed (as shown) or possibly included in a retractable casing (not shown).

The sewn-in wiring arrangement of FIG. 18A shows a close up of cord 340 running at least partially inside a pocketed area 382 through the bottom of cuff region 324 and out aperture 322. Such an arrangement would be more suitable for lightning (flat) or rounded wires used with either Apple phone brands or their non-Apple competitors including but not limited to Google, Android, Samsung, and the like.

Yet another variation is shown in front view at FIG. 18B (with cord/wire 440 sewn into pocketed area 482) for eventual connection to a power bank (not seen) kept inside compartment 464 accessed via zipper 472.

FIGS. 18C through E are “slits only” charging glove variations that enable the glove wearer to employ his/her own existing phone charging cords, either as fed from a storage pocket 584 in cuff region 524 inside OR outside cuff region (Note, if inside, the cord may be fed through slits 542 in the storage pocket 584 and/or palm face 514). Yet another subset of the foregoing feeds cord/wire 540 through an assigned wire sleeve 584 affixed to the exterior of palm face 514. That sleeve may be openable/closeable with a Velcro® taped elongate strip (not shown).

The close up view at FIG. 18E shows using both external glove slits 642 AND stitched channels 688 for glove wearers to thread their own charging wires there through after purchasing the gloves of this invention.

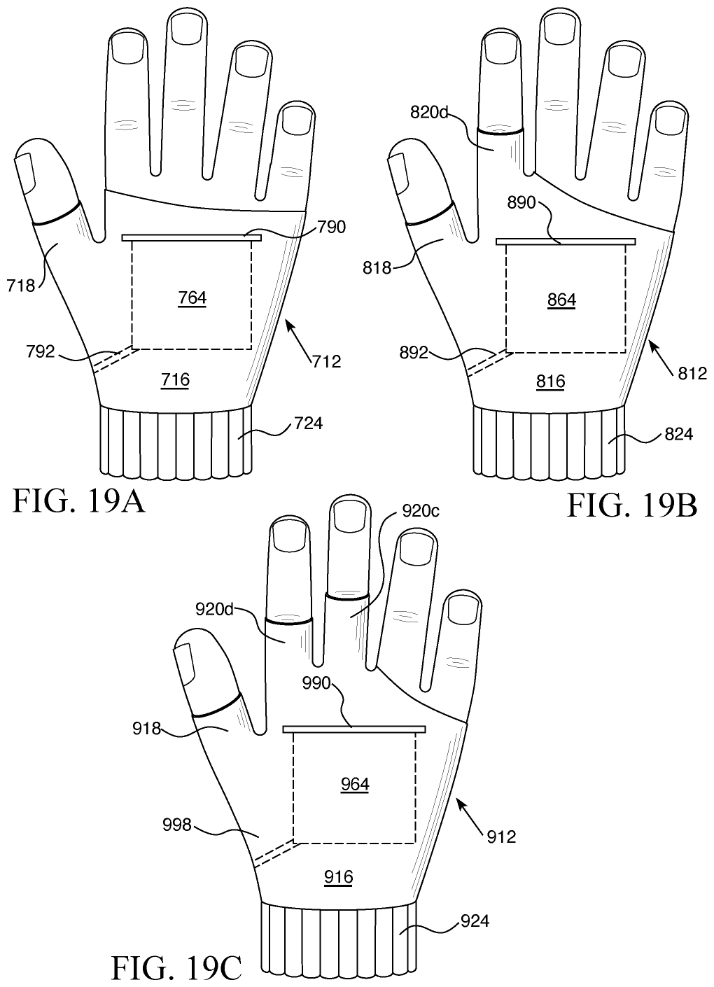

Finally, FIGS. 19A through C show three different variations of back glove POCKET power pack holders. The first of these, FIG. 19A, includes a thumb hole 718 for slipping onto the wearer's ungloved hand—or over and about the rest of an existing covered glove arrangement. The glove portion includes a pocket 764, accessible through power slot 790 with a lower corner portal 792 through which a charging cord connector may be fed. FIG. 19B shows a first variation of the FIG. 19A glove with a pointer finger hole 820d added to its thumb hole 818. Still other ONE finger variations may include a single digit (besides the pointer finger).

FIG. 19C shows yet another hand/glove back pocket configuration that encases two fingers 920c and 920d along with thumb hole 918. This second finger can be used for inserting the wearer's middle finger as part of a combined two-finger packet (both pointer AND middle finger); or supplied with two separate and distinct other two finger holes (not shown).

Needless to say, the materials for making the aforementioned glove bodies are not critical to this invention. They may include gloves for appearance (i.e., leather, fur and the like) or practicality (waterproof versions) or any suitable alternative. They may be fingerless, as shown above. Or they may even be made into more of a mitten variation (not shown). Ideally, the gloves would be made specific for left-handed use, right-handed use, OR made and sold for either wearer hand (i.e., include power bank holders on the fronts or backs of BOTH glove hands, interchangeably). Most preferably, these glove interiors would be supplied with a temperature and radiation-barrier inner liner so as to remove any remote possibility of hurting the wearer's hand(s) while holding his/her phone AND charging it while holding the same.

In some cases, supplemental phone holding straps (not shown) OR phone holding pockets that can still be transmitted (spoken AND heard) through can be further added to the face/palm sides of any of the foregoing models.

### SEQUENCE LISTING

Not applicable.

Having described the presently preferred embodiments, it is to be understood that this invention may also be covered by the scope of one or more of the following product claims.

1. A wearable glove recharger for a small mobile handheld device, said glove recharger including a handheld device charging pad in a palm region of the wearable glove.

2. The wearable glove recharger of claim 1 wherein the small mobile handheld device is a cell phone and the charging pad is wireless.

3. The wearable glove recharger of claim 2 wherein the charging pad is circular, rectangular or trapezoidal-shaped.

4. The wearable glove recharger of claim 1 wherein the wearable glove is fingerless.

5. The wearable glove recharger of claim 1 wherein an inner palm region of the wearable glove includes at least one of: a temperature liner and a waterproof liner.

6. The wearable glove recharger of claim 5 wherein an inner palm region of the wearable glove includes a radiation resistant liner.

7. The wearable glove recharger of claim 1, which includes a USB charging wire in a main body of the wearable glove.

8. The wearable glove recharger of claim 1, which includes a USB charging wire in a cuff region of the wearable glove.

9. The wearable glove recharger of claim 8 wherein the USB charging wire is in a front cuff region of the wearable glove.

10. The wearable glove recharger of claim 8 wherein the USB charging wire is in a side cuff region of the wearable glove.

11. The wearable glove recharger of claim 8 wherein the USB charging wire is in a rear cuff region of the wearable glove.

12. A glove that includes a rechargeable power bank for use with a cellular phone or other handheld electronic device.

13. The glove of claim 12 wherein the power bank is stored in a cuff of the glove.

14. The glove of claim 12 wherein the power bank is stored in a back hand region of the glove, opposite the palm region of the glove.

15. The glove of claim 12, which is fingerless.

16. The glove of claim 12 wherein an inner palm region of the glove includes at least one of: a temperature liner, a waterproof liner and a radiation resistant liner.

17. The glove of claim 12, which includes a USB charging wire in a main body of the glove.

18. The glove of claim 12, which includes a USB charging wire in a front, side or rear cuff region of the glove.
